(19) United States
(12) Patent Application Publication
(10) Pub. No.: US 2007/0294874 A1
(43) Pub. Date: Dec. 27, 2007

(54) METHOD OF FABRICATING HIGH-PRESSURE GAS CYLINDER

(76) Inventor: Kyung Jun Yang, Seoul (KR)

Correspondence Address: HAMMER & HANF, PC, 3125 SPRINGBANK LANE, SUITE G, CHARLOTTE, NC, 28226, US

(21) Appl. No.: 11/761,426

(22) Filed: Jun. 12, 2007

(30) Foreign Application Priority Data
Jun. 21, 2006 (KR) 10-2006-0056795
Apr. 17, 2007 (KR) 10-2007-0037558

(51) Int. Cl. B23P 17/00

(52) U.S. Cl. 29/421.1

(57) ABSTRACT

Disclosed herein is a method of fabricating a high-pressure gas cylinder, the method comprising providing a cylinder body having at least one opened end portion, providing a gas for preventing oxide film-formation on an inner surface of the cylinder body, heating the opened end portion of the cylinder body, and reducing an opened area of the opened end portion by compressing the opened end portion. In the process for deforming or deforming end portions of the cylinder body, the oxide film is prevented from being formed on the inner surface of the cylinder body and the cylinder body is plastic-deformed, thereby preventing the plated layer having been formed from being damaged.

### CROSS-REFERENCE TO RELATED APPLICATION

This application claims priority from Korean Patent Application Nos. 10-2006-0056795, filed on Jun. 21, 2006, and 10-2007-0037558 filed on Apr. 17, 2007 in the Korean Intellectual Property Office, the entire disclosure of which are incorporated herein by reference.

### BACKGROUND OF THE INVENTION

1. Field of the Invention

Methods and apparatuses consistent with the present invention relate to a method of fabricating a high-pressure gas cylinder, and more particularly, the present invention relates to a method of fabricating a high-pressure gas cylinder, which prevents an oxide film from being formed on an inner surface of the high-pressure gas cylinder, so that excellent surface treatment for the inner surface of the high-pressure gas cylinder is realized.

2. Description of Related Art

A various kinds of industrial gases have been used in industry fields such as biochemistry, precision machinery industry, medical science, semiconductor industry etc., according to diverse purposes. However, in a process in which corrosive gases or high-purity gases are used, appropriate countermeasures are required to prevent any chemical reaction produced between an inner peripheral surface of a container for storing gases therein and gases to be charged in the container.

Accordingly, a method of manufacturing a high-pressure gas cylinder by using only materials which are chemically stable for the above described industrial gases has been proposed. Of these, nickel is representative material. However, since a high-purity raw material such as nickel is scarcely commercially available, a high-pressure gas cylinder manufactured using only nickel results in higher manufacturing costs. Also, a gas cylinder made of only above described high-purity materials has several disadvantages in that a high-pressure charge is difficult and high costs are required for its transportation and storage, as compared to a gas cylinder made of steel. Further, in the case of the gas cylinder made of only the above described high-purity material, more gas cylinders are required than in the case of the gas cylinder made of steel, when a gas having an equivalent volume is stored in the respective cylinders.

An alternative method of manufacturing a high-pressure gas cylinder has been proposed in which a material chemically stable for the above described industrial gases is plated onto an inner surface of a gas cylinder made of steel. However, a hot spinning is carried out at a high temperature so as to form a gas cylinder. As a result, an oxide film is formed either on an inner surface of the cylinder or on a layer having been plated. The oxide film, which is formed in a closing process, may reduce an adhesion between the gas cylinder and a plated layer. Also, an oxide film formed on the plated layer may react with specific gases such as hydrogen fluoride (HF), hydrogen bromide (HBr), and hydrogen chloride (HCl), and thus an inner surface of a gas cylinder is exposed to the specific gases. When the specific gases react with the gas cylinder or the oxide film, properties of the reacted gases are deteriorated.

FIGS. 6 and 7 are magnified photographs of a gas cylinder in which a hot spinning is carried out.

Referring to FIG. 6, an oxide film is formed on an inner surface of a high-pressure gas cylinder made of steel. In general, an oxide film may be formed on an inner surface of a high-pressure gas cylinder after closing a lower portion or forming an entrance opening of an upper end portion of a conventional cylinder, and a plurality of deep blind holes into which the oxide film is infiltrated may be generated. The oxide film formed on the inner surface of the high-pressure gas cylinder may reduce an adhesion force of the plated layer.

Referring to FIG. 7, when forming an upper portion of a high-pressure gas cylinder having a nickel plating layer formed on the inner surface thereof, the gas cylinder is plastic flowed with a plated layer and an oxide film formed on the inner surface thereof while being plastic-deformed by the hot spinning. As a result, the oxide film infiltrates into the plated layer, and thus complete protection for a material of a high-pressure gas cylinder becomes difficult due to the oxide film infiltrating into the plated layer.

When a corrosive or high-purity gas is directly contact with the inner surface of the high-pressure gas cylinder, a chemical reaction is produced between the gas cylinder and the gas, physical and chemical properties of the gas is affected, thereby significantly deteriorating properties of the gas.

In order to overcome the above mentioned problems, in a conventional method of manufacturing a high-pressure gas cylinder, a process in which an oxide film is removed by chemical and mechanical methods before carrying out a hot spinning or performing plating is additionally performed. However, it is difficult to completely remove the oxide film from the whole inner surface through the process, and there is no suitable method for verifying whether the oxide film is completely removed.

Further, when a surface treatment such as a barrel finishing is performed on the inner surface of the high-pressure gas cylinder, a smooth surface cannot be obtained due to the remaining oxide film even though the barrel finishing is performed.

### SUMMARY OF THE INVENTION

An aspect of the present invention provides a method of fabricating a high-pressure gas cylinder in which an excellent plated layer is formed so that inherent properties of gases can be maintained for corrosive gases or high-purity gases.

Another aspect of the present invention provides a method of fabricating a high-pressure gas cylinder in which oxide film-formation is prevented when the inner surface of the gas cylinder is subjected to a process with high temperature atmosphere such as a hot spinning.

Still another aspect of the present invention provides a method of fabricating a high-pressure gas cylinder in which an oxide film is prevented from infiltrating into a plated layer when the gas cylinder is plastic-deformed in a high-temperature atmosphere.

Yet another aspect of the present invention provides a method of fabricating a high-pressure gas cylinder in which an excellent surface treatment is realized, thereby increasing reliability of the gas cylinder even though corrosive gases or high-purity gases are used.

According to an aspect of the present invention, there is provided a method of fabricating a high-pressure gas cylinder, the method comprising providing a cylinder body having at least one opened end portion, providing a gas for preventing oxide film-formation on an inner surface of the cylinder body, heating the opened end portion of the cylinder body, and reducing an opened area of the opened end portion by compressing the opened end portion. Here, the gas for preventing oxide film-formation functions to prevent an oxide film from being formed on the inner surface of the high-pressure gas cylinder or a plated layer. Accordingly, a process for removing the oxide film may be omitted although a hot spinning is carried out, and even when the process for removing an oxide film is performed, the oxide film does not infiltrate or make holes into the inner surface of the gas cylinder or the plated layer, thereby completely removing the oxide film. Also, when a surface treatment such as a barrel finishing is performed, a clean and smooth surface can be obtained.

The method of fabricating a high-pressure gas cylinder according to the present invention is employed when forming an entrance opening of the gas cylinder by deforming an upper end portion of a gas cylinder with a bottom formed on the gas cylinder. In this instance, the gas cylinder with the bottom may be a spun cylinder, a deep drawn and ironed (DDI) cylinder, a billet pierced cylinder and the like, and may be formed by a variety methods. In addition, the method according to the present invention may be employed in the case where the bottom of the gas cylinder is formed by closing the lower end portion of the cylinder body.

The gas for preventing oxide film-formation is provided by using an inert gas, a hydrocarbon gas, a reductive gas, or any combination thereof. The gas for preventing oxide film formation prevents the inner surface of the high-pressure gas cylinder from being contacted with oxygen, and reduces an oxide formed on the inner surface of the high-pressure cylinder body, so that a condition where an oxide film is formed on the inner surface of the high-pressure gas cylinder can be inherently prevented from being produced.

Further, preferably, the gas for preventing oxide film-formation is continually provided during the whole process for closing an end portion of the gas cylinder by heating, however, is intermittently provided according to conditions of processes.

According to another aspect of the present invention there is provided a method of fabricating a high-pressure gas cylinder, the method comprising providing a cylinder shaped cylinder body, closing a lower portion of the cylinder body by providing a gas for preventing oxide film-formation on an inner surface of the cylinder body, plating an inner periphery surface of the cylinder body with the closed lower portion; and forming an entrance opening on an upper portion of the cylinder body by providing a gas for preventing oxide film-formation on an inner surface of the cylinder body.

Both lower bottom of the gas cylinder and entrance opening for an upper end portion of the gas cylinder are formed through hot spinning processes. In the hot spinning processes, a gas for preventing oxide film-formation is used to prevent an oxide film from being formed. Accordingly, although plating is performed between hot spinning processes, a process for removing an oxide film is either omitted or readily performed, thereby completely performing the plating process. When a surface treatment such as a barrel finishing is performed, a clean and smooth surface can be obtained.

Further, when a process for forming an entrance opening of the cylinder body is performed, an oxide film is prevented from being formed, preventing the oxide film from being infiltrated into the plated layer due to a plastic-flow of the plated layer and the oxide film.

In the operation of closing the lower end portion of the cylinder body and forming an entrance opening of the upper end portion of the gas cylinder body, equivalent gases or different gases for preventing oxide film-formation may be used. The gases for preventing oxide film-formation may be provided by using an inert gas, a hydrocarbon gas, a reductive gas or any combination thereof.

In the operation of plating the inner surface of the cylinder body, any one of electroplating and electroless plating may be performed, however, preferably, the electroplating is performed. Also, the plating process may be performed by using materials which are chemically stable for corrosive gases or high-purity gases, etc. Of these, nickel is a representative material.

In addition, according to another aspect of the present invention there is provided a method of fabricating a high-pressure gas cylinder, the method comprising providing a cylinder shaped cylinder body, closing a lower portion of the cylinder body by providing a gas for preventing oxide film-formation on an inner surface of the cylinder body, forming an entrance opening on an upper portion of the cylinder body by providing a gas for preventing oxide-formation on an inner surface of the cylinder body, and plating an inner surface of the cylinder body with the formed entrance opening.

Both a lower bottom and an entrance opening of the upper end portion of the cylinder body are formed through a hot spinning process by using the gas for preventing oxide film-formation, and then a plating process is performed. In an operation of the plating the inner surface of the cylinder body, any one of electroplating and electroless plating may be performed, however, preferably, the electroless plating is performed. Also, the plating process may be performed by using materials which are chemically stable for corrosive gases or high-purity gases, and the like. Of these, nickel is representative material.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a configuration view illustrating a method of fabricating a high-pressure gas cylinder according to an embodiment of the present invention;

FIG. 2 is a flowchart illustrating the method of fabricating the high-pressure gas cylinder of FIG. 1;

FIG. 3 is a configuration view illustrating a method of fabricating a high-pressure gas cylinder according to another exemplary embodiment of the present invention;

FIG. 4 is a flowchart illustrating the method of fabricating a high-pressure gas cylinder according to still another embodiment of the present invention;

FIG. 5 is a flowchart illustrating the method of fabricating a high-pressure gas cylinder according to still another embodiment of the present invention;

FIGS. 6 and 7 are magnified photographs of a gas cylinder in which a hot spinning is carried out according to a conventional method of fabricating a high-pressure gas cylinder; and

FIG. 8 is a magnified photograph of a plated layer after closing an upper end portion of a gas cylinder with a nickel plated thereon according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

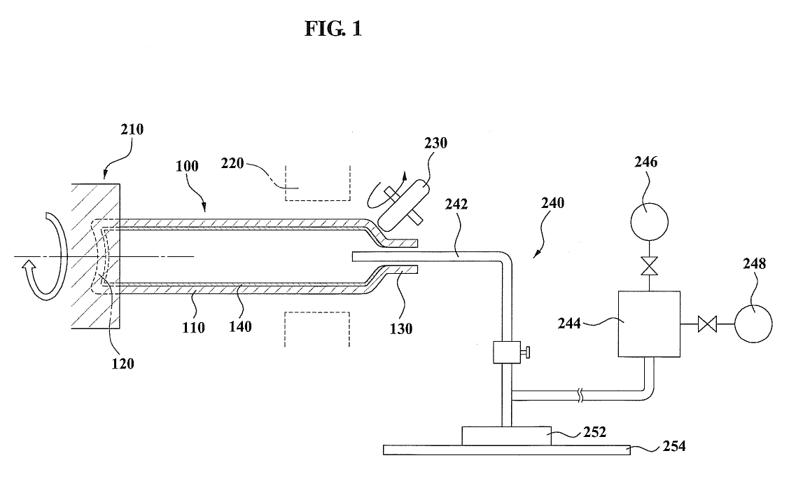

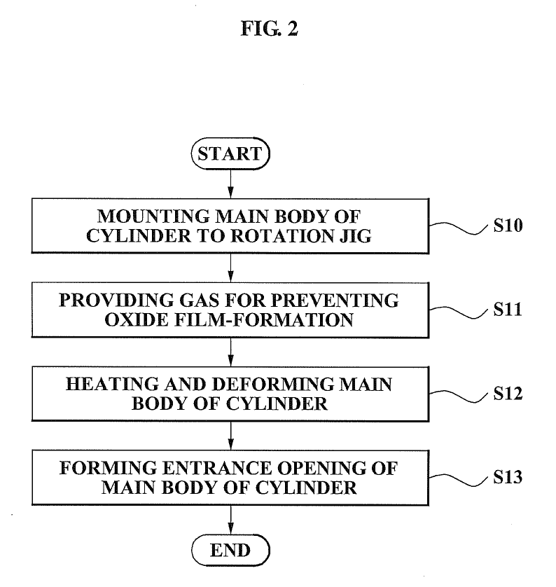

FIG. 1 is a configuration view illustrating a method of fabricating a high-pressure gas cylinder according to an exemplary embodiment of the present invention and FIG. 2 is a flowchart illustrating the method of fabricating a high-pressure gas cylinder of FIG. 1.

Referring to FIGS. 1 and 2, a cylinder body of a high-pressure gas cylinder 100 comprises a closed bottom 120 and an opened upper end portion. The opened upper end portion may be formed into an entrance opening 130 of the cylinder body through a hot spinning process. In order to form the entrance opening 130, a rotation jig 210 for fixing and rotating the cylinder body 110 is used, and a heater 220 is placed around the outer peripheral surface of the cylinder body 110. Also, a forming roller 230 is placed around the outer peripheral surface of the entrance opening 130 to compress and form an upper end portion of the cylinder body 110 having been heated.

A gas injecting apparatus 240 is provided in an inner space of the fixed cylinder body 110. The gas injecting apparatus 240 comprises a nozzle 242 inserted into the inner space of the cylinder body 110, a pair of gas supplying units 246 and 248 for supplying an inert gas, a reductive gas, and the like, and a mixing unit 244 for supplying a gas through the nozzle 242 or mixing gases. Also, the gas injecting apparatus 240 may comprise a position-adjusting unit 252 for adjusting a position of the nozzle 242, and a guide rail 254. The position of the nozzle 242 is adjusted according to the guide rail 254.

In operation S10, the cylinder body 110 of the high-pressure gas cylinder is mounted to the rotation jig 210, in operation S11, a gas for preventing oxide film-formation is supplied to the inner space of the cylinder body 110 mounted to the rotation jig 210 by using the gas injecting apparatus 240, and in operation S12, the cylinder body is heated by the heater 220 and plastic-deformed by means of the forming roller 230. The entrance opening 130 is formed through the operations. Alternatively, in operation S14, a post-process may be performed in such a manner that a threaded portion is formed on the inner peripheral surface of the entrance opening, or the threaded portion is re-plated.

According to an exemplary embodiment of the present invention, the high-pressure gas cylinder 100 having a closed lower bottom and an opened upper end thereof is provided before performing processes. The cylinder body 110 having an opened end thereof is provided according to the method of fabricating the cylinder body 110. In order to fabricate the cylinder body 110, a spun cylinder may be provided by the hot spinning, or alternatively, a deep drawn and ironed (DDI) cylinder and a billet pierced cylinder may be provided by a deep drawing and Elrhardt methods, respectively.

For reference, the spun cylinder is made of a material formed in a pipe-shape and is subjected to the hot spinning so as to form the lower and upper portions of the high-pressure gas cylinder. The DDI cylinder is produced such that a material formed in a disk-shape is subjected to a self-lubricating treatment, and then is subjected to the deep drawing process or a pressing process, thereby obtaining a cylinder having a bottom. Also, the billet pierced cylinder is made of a material preliminarily molded into a chunk-shape. Here, a basic shape of the billet pierced cylinder is formed by performing punching on a upper portion of the material, and then a bottom of the billet pierced cylinder is formed. When forming the lower portions of the DDI cylinder and the billet pierced cylinder, a process such as the hot spinning is not performed.

An oxide film may be removed after the cylinder body 110 having the bottom 120 formed thereon is manufactured. For example, an oxide film may be formed on an inner peripheral surface of a pipe-shaped raw material manufactured by a conventional Mannesmann process after the raw material has been cut. Since the oxide film as described above provides adverse effects on a plated layer while a plating process is being performed and deteriorates reliability of the high-pressure gas cylinder, preferably, it is previously removed by a chemical or mechanical method. For this purpose, any one of three methods, which will be described as follows, may be selected.

First, a chemical method such as an acid treatment and the like is used. Second, a method using a honing is used, in which a pipe, as a raw material of a high-pressure gas cylinder is fixed, and a grinding apparatus designed in such a manner as to have an uniform contact pressure with the inner peripheral surface of the pipe is moved in a lengthwise direction of the pipe, thereby removing an oxide film formed on the inner peripheral surface of the pipe due to a frictional force generated between the grinding apparatus and the pipe. Third, a method using a cutting blade is used, in which the inner peripheral surface of the pipe is subjected to a cutting process, thereby forcibly removing the oxide film.

Now, referring to FIG. 2, in operation S11, a gas for preventing oxide film-formation is supplied to the inner space of the cylinder body 110. Here, the gas for preventing oxide film-formation may be selected from inert gases such as nitrogen gas and argon gas, hydrocarbon gases such as hydrogen gas and natural gas, or reductive gases such as ammonia decomposition gas. Also, any combination of these gases may be used.

An oxide film may be formed on the inner surface of the high-pressure gas cylinder while a process for forming upper and lower portions of the high-pressure gas cylinder is being performed at a high-temperature atmosphere which will be described below. Here, in the case where a plated layer 140 has already been formed, the oxide film may be formed. The oxide film may infiltrate into the plated layer 140 by a plastic-flow of the oxide film 140 and the plated layer 140 upon plastic-deforming for the entrance opening 130 of the cylinder body. However, according to an exemplary embodiment of the present invention, since the gas for preventing oxide-film formation is continually or intermittently supplied during the whole forming process, the oxide film can be prevented from being formed on the inner surface of the cylinder body.

The oxide film may induce defects in the plated layer in such a manner to reduce an adhesion force between the gas cylinder and the plated layer, or generate pin holes. Further, a charged corrosive gas or high-purity gas may directly contact with the inner surface of the gas cylinder due to the defects in the plated layer, so that properties of the charged gas is significantly deteriorated upon producing a chemical reaction between the charged gas and the inner surface of the gas cylinder.

Thus, in the method of fabricating a high-pressure gas cylinder according to an exemplary embodiment of the present invention, the gas for preventing oxide film-formation is supplied during forming of the cylinder body 110 so as to prevent the inner surface of the cylinder body and oxygen from being contacted with each other. Also, an oxide formed in the cylinder body is reduced, thereby preventing a condition of forming an oxide film on the inner surface of the high-pressure gas cylinder from being created.

Accordingly, in the method of fabricating a high-pressure gas cylinder according to an exemplary embodiment, an additional process for removing an oxide film is not necessary, and the oxide film is completely removed when the oxide film is removed afterward, unlike the conventional method of fabricating an upper or lower portions of the high-pressure gas cylinder.

The gas injecting apparatus 240 supplies the gas for preventing oxide film-formation into the inner space of the cylinder body 110, and moves to effectively supply the gas for preventing oxide film-formation according to forming processes. The gas injecting apparatus 240 comprises a nozzle 242 for injecting a gas into the cylinder body 110, a gas supplying-pipe, an adjusting valve for adjusting an injected amount of mixed gases, an adjusting valve for adjusting an injected amount of individual gases, and a mixing unit 244. An injected amount of individual gases consisting of mixed gases is adjusted through the adjusting valve for adjusting an injected amount of individual gases, and individual gases are uniformly mixed through the mixing unit 244. Further, the adjusting valve for adjusting an injected amount of mixed gases adjusts an injected amount of mixed gases supplied to the inner space of the cylinder body 110, and the mixed gases are supplied from the nozzle 242 to the inner space of the cylinder body 110 via the gas supplying-pipe.

The process for supplying the gas for preventing oxide film-formation is performed during the whole process for forming the entrance opening of the cylinder body. Specifically, the gas may be supplied at least 10 seconds prior to heating by the heater 220 and a process by the forming roller 230, and continually supplied until the forming is completed. Also, an injected amount of the gas for preventing oxide film-formation may be more than 50% of an inner volume of the high-pressure gas cylinder based upon air expanding by heating.

Preferably, when the entrance opening 130 of the high-pressure gas cylinder 100 is formed, a gas for preventing oxide film-formation may be supplied at a speed in which the gas is supplied in five minutes or less, in such a manner as to have the same volume as the inner volume of the high-pressure gas cylinder 100. For example, in the case of having a volume of the gas cylinder of 50 liters, the gas is supplied at a speed of at least 10 liter/min. When the gas is supplied at a lower speed than the above-mentioned speed, the oxide film-formation is not effectively prevented.

In the process for forming the entrance opening of the cylinder body 110, a ductility is obtained by heating, so that an end portion of the cylinder body 110 is formed into a narrowed entrance opening shape by the forming roller 230. In addition, a hole process and a threaded portion-formation, and the like, may be performed, so that an oxide film is prevented from being formed or effectively removed, thereby preventing the oxide film from being infiltrated into the plated layer.

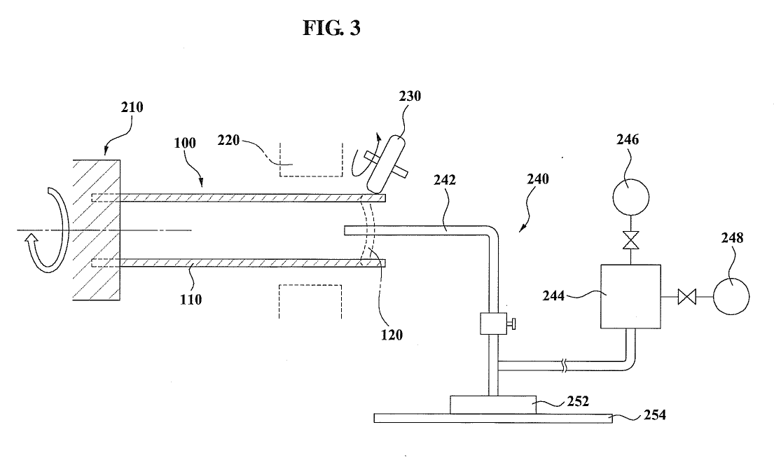

FIG. 3 is a configuration view illustrating a method of fabricating a high-pressure gas cylinder according to another exemplary embodiment of the present invention. For reference, as can be seen from FIG. 3, the cylinder body 110 has opened both end portions, and the cylinder body having been subjected to a method illustrated in FIG. 3 may be used for forming an entrance opening of FIG. 1.

Referring to FIG. 3, the cylinder body 110 is provided with opened both end portions and a closed bottom 120 by the hot spinning. In order to form the bottom 120, the rotation jig 210 for fixing or rotating the cylinder body 110 is used, and the heater 220 and the forming roller 230 is provided around an outer peripheral surface of the cylinder body 110. Further, the gas injecting apparatus 240 is provided to the inner space of the fixed cylinder body 110, so that an inert gas or a reductive gas, and the like, can be supplied to the inner space of the cylinder body 110.

In order to form the bottom 120 of the cylinder body 110, the process described with reference to FIG. 2 may be performed in an almost identical manner. When the bottom 120 of the cylinder body 110 is formed, a gas for preventing oxide film-formation may be supplied at a speed, in which the gas is supplied in five minutes or less, in such a manner as to have the same volume as the inner volume of the high-pressure gas cylinder 100. Specifically, the gas may be continually supplied until the temperature of the surface of the cylinder body 110 is down to a temperature of 250° C.

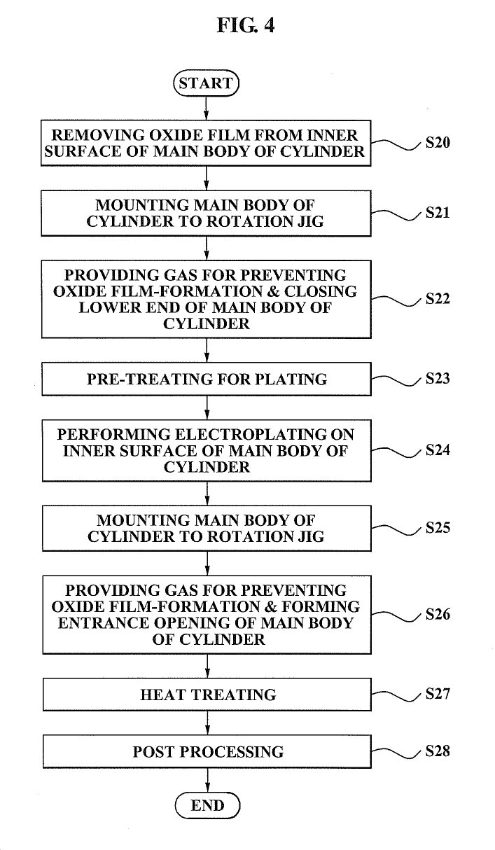

FIG. 4 is a flowchart illustrating the method of fabricating a high-pressure gas cylinder according to still another embodiment of the present invention.

Referring to FIG. 4, both a bottom and an entrance opening of the cylinder body are formed by the hot spinning. Here, since the gas for preventing oxide film-formation is used even when performing the hot spinning, the oxide film is prevented from being formed on the inner surface of the cylinder body or the plated layer.

In operation S20, the oxide film formed on the inner surface of the cylinder body is removed. As described above, an oxide film may be formed on an inner peripheral surface of a pipe-shaped raw material manufactured by the Mannesmann process after the raw material has been cut. The oxide film is removed by chemical and mechanical methods.

Since the oxide film remaining on the cylinder body provides adverse effects on the plated layer, and deteriorates reliability of the high-pressure gas cylinder, preferably, it is previously removed by a chemical or mechanical method.

In operation S21, after removing the oxide film, the cylinder body having opened both end portions is mounted to the rotation jig. The lower portion, that is, a bottom, of the cylinder body is closed by the hot spinning, and the rotating jig fixes and rotates the cylinder body in order to form the bottom.

In operation S22, the gas for preventing oxide film-formation is supplied to the cylinder body and the bottom is closed by the forming roller while the cylinder body is being rotated by the rotation jig. In order to close the bottom of the cylinder body, the heater, the forming roller and the gas injecting apparatus are provided around the outer peripheral surface of the cylinder body. Here, the gas for preventing oxide film-formation may be selected from inert gases such as nitrogen gas and argon gas, hydrocarbon gases such as hydrogen gas and natural gas, or reductive gases such as ammonia decomposition gas. Also, any combination of the gases may be used.

The oxide film may induce defects in the plated layer in such a manner to reduce an adhesion force between the gas cylinder and the plated layer, or generate pin holes. Further, a charged corrosive gas or high-purity gas may directly contact with the inner surface of the gas cylinder due to the defects in the plated layer, so that properties of the charged gas is significantly deteriorated upon producing a chemical reaction between the inner surface of the gas cylinder and the charged gas.

According to an exemplary embodiment of the present invention, the gas for preventing oxide film-formation is sprayed from the nozzle of the gas injecting apparatus. As a result, the gas remains in the inner space of the cylinder body, thereby preventing an oxide film from being formed on the inner surface of the cylinder body. The process for supplying the gas for preventing oxide film-formation is performed during the whole process for forming the bottom. Specifically, the gas is supplied at least 10 seconds prior to heating by the heater and a process by the forming roller, and continually supplied until the forming is completed. Also, an injected amount of the gas for preventing oxide film-formation may be more than 50% of an inner volume of the high-pressure gas cylinder based upon air expanding by heating.

Preferably, when the bottom of the high-pressure gas cylinder is formed by closing the lower end portion thereof, a gas for preventing oxide film-formation may be supplied at a speed, in which the gas is supplied in five minutes or less, in such a manner as to have the same volume as the inner volume of the high-pressure gas cylinder. For example, in the case of having a volume of the gas cylinder of 50 liters, the gas is supplied at a speed of at least 10 liter/min. When the gas is supplied at a lower speed than the above-mentioned speed, the oxide film-formation is not effectively prevented. In this instance the gas may be continually supplied until the temperature of the surface of the cylinder body is down to a temperature of 250° C. In addition, mixed gases of nitrogen and hydrogen are supplied to the cylinder body having an inner volume of 24 liters at a speed about 30 liter/min, thereby preventing the oxide film from being formed.

In the process for forming the bottom of the cylinder body, a ductility is obtained by heating the cylinder body, so that an end portion of the cylinder body is deformed to be closed.

In operation S23, a process for removing foreign substances and an oxide film existing on the inner surface of the cylinder body before performing plating, that is, a pre-treatment process for plating is performed. The process for removing foreign substances and an oxide film may be selected from the following two methods.

First, a chemical method such as an acid treatment and the like is used. Second, a mechanical method such as a grit blast is used. The grit blast particles such as glass, polymer, sand, and steel based materials are sprayed to an inner surface of the cylinder body to be plated at a high pressure of about 3 to 35 kgf/cm² so as to remove foreign substances, and the like.

Foreign substances and an oxide film existing on the inner surface of the cylinder body are removed and the inner surface is coarsened through the above-described process, thereby increasing an adhesion force between the material of the inner surface of the cylinder body and the plated layer.

In addition, a pre-treatment process for plating is performed by a chemical or electrochemical method. For example, degreasing using a basic solution or pickling using an acid solution, and the like, is performed so as to ensure the adhesion property of the plated layer.

In operation S24, the inner surface of the cylinder body is plated after performing the pre-treatment process for plating.

In the operation of plating the inner surface of the cylinder body, any one of electroplating and electroless plating may be performed, however, the electroplating is performed according to an exemplary embodiment of the present invention. Also, the plating process may be performed by using materials which are chemically stable for corrosive gases or high-purity gases, etc. Of these, nickel is a representative material.

The method of fabricating a high-pressure gas cylinder according to an exemplary embodiment provides the gas for preventing oxide film-formation and performs the hot spinning, thereby preventing an oxide film from being formed on the inner surface of the cylinder body. Accordingly, although a process for removing the oxide film by a chemical and mechanical method is not additionally performed before performing plating, a sufficient plated layer having a high-quality may be obtained, however, the process for removing the oxide film may be applied, as necessary.

The electroplating is performed such that the whole cylinder body is immersed in a tank for plating, and an anode is installed in such a manner that a center of the cylinder body and a center of the anode correspond to each other. A distance between the inner circumferential surface of the cylinder body and the outer peripheral surface of the anode must be uniformly maintained in the lower portion and opened portion of the cylinder body, so that the plated layer formed on the inner surface of the cylinder body can have an uniform thickness in a circumferential direction of the cylinder body. The reason for this is because the center of the gas cylinder body and the center of the anode must correspond to each other and respective vertical direction vectors of the gas cylinder body and the anode must have similarities to a certain degree with each other.

When the vertical direction vectors don't have similarities to a certain degree with each other, even when the anode is positioned at the center of the inner surface of the gas cylinder body in a specific position, the gas cylinder body acting as a cathode of the electroplating system abuts against the upper or lower portion of the anode or relative high-current and low-current portions are generated, thereby failing to obtain a required plated layer.

Also, the anode has a purity of more than 99% in order to continually supply a metal, such as nickel, to be plated. The anode is designed in such a manner as to be spaced apart from the inner surface of the gas cylinder body by a predetermined distance in conformity with the size and shape of the inner surface of the cylinder body, so that a thickness of a plated layer is uniformly maintained over the whole inner surface of the gas cylinder body. Preferably, the distance between the gas cylinder body and the anode is maintained to be about 10 to 100 cm.

To overcome defects in the plated layer formed on the inner surface of the cylinder body, the plated layer may be formed in such a manner as to have a thickness of more than 20 μm from the inner surface of the high-pressure gas cylinder when performing electroplating. Preferably, the plated layer has a thickness of more than 200 μm. However, the plated layer preferably has a thickness of smaller than 2,000 μm in consideration of time and costs required for plating.

In the performing electroplating, to realize a nickel-plated layer on the inner surface of the high-pressure gas cylinder body, a nickel chloride solution, a nickel sulfate solution, a nickel sulfamate solution, and a nickel fluoborate solution may be used.

When a nickel chloride solution for a nickel plating is used, the nickel chloride solution has a nickel chloride concentration of 50 to 500 g/L, a boric acid concentration of 5 to 50 g/L, a pH in the range of 0.5 to 6.5, a use temperature of 20 to 95° C., and a use voltage of 3 to 20 V.

Also, when a nickel sulfate solution for a nickel plating is used, the nickel sulfate solution has a nickel sulfate concentration of 100 to 500 g/L, a boric acid concentration of 5 to 50 g/L, a nickel chloride concentration of 2 to 80 g/L, a pH in the range of 1 to 6.5, a use temperature of 20 to 95° C., and a use voltage of 3 to 20 V.

In addition, when a nickel sulfamate solution for a nickel plating is used, the nickel sulfamate solution has a nickel sulfamate concentration of 100 to 500 g/L, a boric acid concentration of 5 to 50 g/L, a nickel chloride concentration of 2 to 80 g/L, a pH in the range of 1 to 6.5, a use temperature of 20 to 95° C., and a use voltage of 3 to 20V.

Finally, when a nickel fluoborate solution for a nickel plating is used, the nickel fluoborate solution having a nickel fluoborate concentration of 40 to 500 g/L, a boric acid concentration of 5 to 50 g/L, a pH in the range of 1 to 6.5, a use temperature of 20 to 95° C., and a use voltage of 3 to 20 V.

In operation S25, the cylinder body is re-mounted to the rotation jig in such a manner as to allow the opened upper portion of the cylinder body to be exposed to the outside after performing plating on the cylinder body with a bottom. In operation S26, an entrance opening of the cylinder body is formed by using a gas for preventing oxide film-formation.

The cylinder body is mounted to the rotation jig and an entrance opening of the cylinder body is formed by using the hot spinning, in a similar manner as that of the above operations S21 and S22. The gas for preventing oxide film-formation has the same composition and proportion as that used in the operation S22, but has a different composition and proportion from that used in the operation S22, as necessary.

FIG. 8 is a magnified photograph of a plated layer after closing an upper end portion of a gas cylinder with a nickel plated thereon according to an exemplary embodiment of the present invention.

As can be seen from FIG. 8, when forming an upper portion of the cylinder body having a plated layer formed on the inner surface thereof according to an exemplary embodiment of the present invention, the cylinder body is plastic-deformed, however, the oxide film does not infiltrate into the plated layer.

In operation S27 and S28, the entrance opening of the cylinder body is formed by the hot spinning, and then a heating treatment and a post-process are performed. In order to perform a heating treatment, the method of fabricating a high-pressure gas cylinder further comprises a quenching process of heating at a temperature of about 800 to 1,000° C. for 30 to 200 minutes and suddenly cooling, and a tempering treatment process of heating at a temperature of about 500 to 723° C. for 20 to 200 minutes and gradually cooling. A hardness and strength of a material of the high-pressure gas cylinder body is improved through the quenching process, and brittleness produced by the quenching process is eliminated and toughness of the material is improved through the tempering treatment process. As a result, the high-pressure gas cylinder has stable mechanical properties through these processes as described above even after a high-pressure gas is charged in the high-pressure gas cylinder.

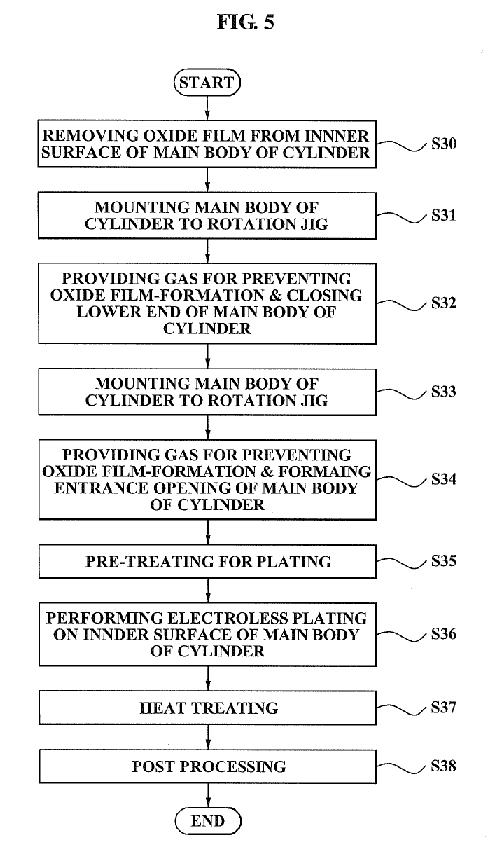

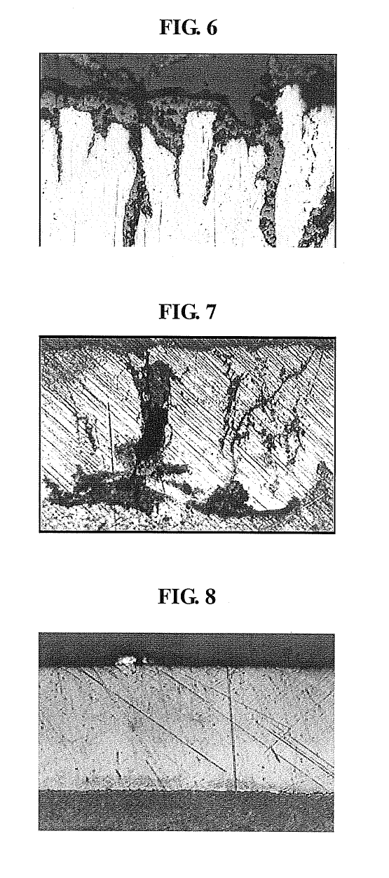

FIG. 5 is a flowchart illustrating the method of fabricating a high-pressure gas cylinder according to still another embodiment of the present invention.

Referring to FIG. 5, both bottom and entrance opening of the cylinder body are formed by the hot spinning, and a plated layer is formed on the inner surface of the cylinder body through electroless plating after completing the hot spinning. In this instance, the electroless plating is performed by using materials which are chemically stable for corrosive gases or high-purity gases. Of these, nickel is representative material.

In operation S30, an oxide film formed on the inner surface of the cylinder body is removed, in operation S31, the cylinder body having opened both end portions is mounted to the rotation jig, in operation S32, a bottom of the cylinder body is formed by using a gas for preventing oxide film-formation, and in operation S33, the cylinder body is re-mounted to the rotation jig. Thereafter, in operation S34, an entrance opening of the cylinder body is formed, and in operation S35, a pre-treatment for plating is performed. The series of these processes are applied in an almost identical manner as the above described embodiments of the present invention.

In operations S37 and S38, a heating treatment and a post process are performed after the entrance opening of the cylinder body is formed by the hot spinning.

In order to perform a heating treatment, the method of fabricating a high-pressure gas cylinder further comprises a quenching process of heating at a temperature of about 800 to 1,000° C. for 30 to 200 minutes and suddenly cooling, and a tempering treatment process of heating at a temperature of about 500 to 723° C. for 20 to 200 minutes and gradually cooling. A hardness and strength of a material of the high-pressure gas cylinder body is improved through the quenching process, and brittleness produced by the quenching process is eliminated and toughness of the material is improved through the tempering treatment process. As a result, the high-pressure gas cylinder has stable mechanical properties through these processes as described above even after a high-pressure gas is charged in the high-pressure gas cylinder.

As described above, according to the method of fabricating a high-pressure gas cylinder of the present invention, an excellent surface treatment is realized, thereby increasing reliability thereof even when corrosive gases or high-purity gases are used.

Also, according to the method of fabricating a high-pressure gas cylinder of the present invention, a gas for preventing oxide film-formation is provided, so that a condition by which an oxide film is formed on the inner surface of the high-pressure gas cylinder body can be inherently prevented from being produced, thereby improving an adhesion force of a plated layer and preventing defects in the plated layer.

In addition, according to the method of fabricating a high-pressure gas cylinder of the present invention, a charged corrosive gas or high-purity gas is prevented from being directly contacted with the inner surface of the high-pressure gas cylinder body, thereby preventing properties of the charged gas from being deteriorated due to the chemical reaction between the gas and the inner surface.

Also, according to the method of fabricating a high-pressure gas cylinder of the present invention, an additional process for removing an oxide film is not necessary, thereby reducing manufacturing costs of the high-pressure gas cylinder body.

Further, according to the method of fabricating a high-pressure gas cylinder of the present invention, when a surface treatment such as a barrel finishing and the like is performed, an oxide film is prevented from being formed on the inner surface of the cylinder body, thereby obtaining a clean and smooth surface.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of fabricating a high-pressure gas, the method comprising:
providing a cylinder body having at least one opened end portion;
providing a gas for preventing oxide film-formation on an inner surface of the cylinder body;
heating the opened end portion of the cylinder body; and
reducing an opened area of the opened end portion by compressing the opened end portion.

2. The method of claim 1, wherein the gas for preventing oxide film-formation is provided using an inert gas, a hydrocarbon gas, a reductive gas, or any combination thereof.

3. The method of claim 1, wherein the provided gas for preventing oxide film-formation is continually or intermittently provided from before the heating the opened end portion of the cylinder body until the completion of the reducing the opened area of the opened end portion.

4. The method of claim 1, wherein an injecting amount of the provided gas for preventing oxide film-formation is more than 50% of an inner volume of the high-pressure gas cylinder based upon air expanding by heating.

5. The method of claim 1, wherein the opened end portion of the reducing the opened area of the opened end portion is closed.

6. The method of claim 1, wherein the opened end portion of the reducing the opened area of the opened end portion has an entrance opening for the high-pressure gas cylinder thereon.

7. A method of fabricating a high-pressure gas cylinder, the method comprising:
providing a cylinder shaped cylinder body;
closing a lower portion of the cylinder body by providing a gas for preventing oxide film-formation on an inner surface of the cylinder body;
plating an inner periphery surface of the cylinder body with the closed lower portion; and
forming an entrance opening on an upper portion of the cylinder body by providing a gas for preventing oxide film-formation on an inner surface of the cylinder body.

8. The method of claim 7, wherein the closing the lower portion of the cylinder body and the forming the entrance opening on the upper portion of the cylinder body use the same gas for preventing oxide film-formation or another gas for preventing oxide film-formation, and the gas is provided using an inert gas, a hydrocarbon gas, a reductive gas, or any combination thereof.

9. The method of claim 7, wherein the plating the inner periphery surface of the cylinder body is performed by electroplating.

10. The method of claim 9, wherein, in the performing electroplating, a plating layer is formed on the inner surface of the cylinder body in such a manner as to have a thickness of 20 to 2,000 μm.

11. The method of claim 9, wherein, in the performing electroplating, a nickel chloride solution for a nickel plating is used, the nickel chloride solution having a nickel chloride concentration of 50 to 500 g/L, a boric acid concentration of 5 to 50 g/L, a pH in the range of 0.5 to 6.5, a use temperature of 20 to 95° C., and a use voltage of 3 to 20V.

12. The method of claim 9, wherein, in the performing electroplating, a nickel sulfate solution for a nickel plating is used, the nickel sulfate solution having a nickel sulfate concentration of 100 to 500 g/L, a boric acid concentration of 5 to 50 g/L, a nickel chloride concentration of 2 to 80 g/L, a pH in the range of 1 to 6.5, a use temperature of 20 to 95° C., and a use voltage of 3 to 20 V.

13. The method of claim 9, wherein, in the performing electroplating, a nickel sulfamate solution for a nickel plating is used, the nickel sulfamate solution having a nickel sulfamate concentration of 100 to 500 g/L, a boric acid concentration of 5 to 50 g/L, a nickel chloride concentration of 2 to 80 g/L, a pH in the range of 1 to 6.5, a use temperature of 20 to 95° C., and a use voltage of 3 to 20V.

14. The method of claim 9, wherein, in the performing electroplating, a nickel fluoborate solution for a nickel plating is used, the nickel fluoborate solution having a nickel fluoborate concentration of 40 to 500 g/L, a boric acid concentration of 5 to 50 g/L, a pH in the range of 1 to 6.5, a use temperature of 20 to 95° C., and a use voltage of 3 to 20 V.

15. A method of fabricating a high-pressure gas cylinder, the method comprising:
providing a cylinder shaped cylinder body;
closing a lower portion of the cylinder body by providing a gas for preventing oxide film-formation on an inner surface of the cylinder body;
forming an entrance opening on an upper portion of the cylinder body by providing a gas for preventing oxide-formation on an inner surface of the cylinder body; and
plating an inner surface of the cylinder body with the formed entrance opening.

16. The method of claim 15, wherein the closing the lower portion of the cylinder body and the forming the entrance opening on the upper portion of the cylinder body use the same gas for preventing oxide film-formation or another gas for preventing oxide film-formation, and the gas is provided using an inert gas, a hydrocarbon gas, a reductive gas, or any combination thereof.

17. The method of claim 15, wherein the plating the inner periphery surface of the cylinder body is performed by electroless plating.
